(19) United States
(12) Patent Application Publication
(10) Pub. No.: US 2012/0023555 A1
(43) Pub. Date: Jan. 26, 2012

(54) WIRELESS ENVIRONMENTAL MONITORING OF GOODS

(76) Inventor: Danieli Gavriel Putterman, Qiryat-Ono (IL)

(21) Appl. No.: 12/841,102

(22) Filed: Jul. 21, 2010

(51) Int. Cl. H04L 9/32; G06Q 30/00; G06F 15/16

(52) U.S. Cl. 726/4; 726/3; 726/5; 705/333

(57) ABSTRACT

A system for wireless environmental monitoring of goods, the system comprising a portable environmental data logger and a portable computerized device, each comprising: a standard short-range radio module; and an authentication and security module, wherein said standard short-range radio modules of said logger and said computerized device are configured to communicate with one another over a standard wireless communication channel, and wherein said authentication and security modules of said logger and said computerized device are each configured to execute, over the standard wireless communication channel, a non-standard authentication routine for authenticating an identity of said computerized device to said logger, so as to provide said computerized device with data access to said logger based on a security profile assigned to said computerized device.

### FIELD OF THE INVENTION

Embodiments of the disclosure relate to the field of wireless environmental monitoring of goods.

### BACKGROUND OF THE INVENTION

Environmental data loggers are devices, sometimes portable, that are often used for sensing and logging environmental information. It is quite common to couple such loggers to shipments of goods, such as pharmaceuticals and articles of food, which are sensitive to environmental parameters like temperature, humidity etc. Long transit periods via air, sea or land, increase the probability that the goods will be exposed to harmful conditions, even if they are protected by suitable packaging or positioned in a climate-controlled environment such as a refrigerator.

The loggers are usually manually inspected upon arrival of the goods to their destination. Loggers often include a visual indication, such as a light, indicating if any extreme environmental conditions have been experienced during the transit. If it is discovered, during the inspection, that the light is on, the goods may be further examined for damage or even discarded. Sometimes, the environmental logs are downloaded from the loggers, such as by using a suitable cable, onto a personal computer. The logs may then be more thoroughly reviewed to understand the nature and the time of the irregular occurrence.

Environmental data loggers are also used for monitoring environmental conditions in permanent storage units, such as warehouses. Multiple loggers may be spread around the warehouse, to record environmental parameters that may affect the stored goods.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, according to an embodiment, a system for wireless environmental monitoring of goods, the system comprising a portable environmental data logger and a portable computerized device, each comprising: a standard short-range radio module; and an authentication and security module, wherein said standard short-range radio modules of said logger and said computerized device are configured to communicate with one another over a standard wireless communication channel, and wherein said authentication and security modules of said logger and said computerized device are each configured to execute, over the standard wireless communication channel, a non-standard authentication routine for authenticating an identity of said computerized device to said logger, so as to provide said computerized device with data access to said logger based on a security profile assigned to said computerized device.

There is further provided, according to an embodiment, a system for shipment tracking and monitoring, the system comprising: a central shipment tracking and monitoring server; a plurality of portable environmental data loggers, each configured to monitor an environmental parameter and to store tracking information pertaining to a shipment; and a plurality of portable computerized devices, each configured to wirelessly access at least one of the loggers so as to receive the environmental parameter, and each comprising a network interface module configured to transmit the environmental parameter to the central shipment tracking and monitoring server.

There is yet further provided, according to an embodiment, a method for wireless environmental monitoring of goods, the method comprising: continuously sensing and recording, using a portable environmental data logger, at least one environmental parameter; opening a wireless communication channel from a portable computerized device to the logger, using a standard short-range radio protocol; and over the wireless communication channel, using a non-standard authentication routine, authenticating an identity of the computerized device to the logger, to provide the computerized device with data access to the logger based on a security profile assigned to the computerized device.

In some embodiments, in the execution of the non-standard authentication routine, said authentication and security module of said logger is further configured to transmit a challenge to the authentication and security module of said computerized device; and said authentication and security module of said computerized device is further configured to transmit a correct response to the challenge to the authentication and security module of said logger, to provide said computerized device with the data access to said logger.

In some embodiments, the correct response is associated with a group of loggers in which said logger is a member.

In some embodiments, the correct response is associated with a group of computerized devices in which said computerized device is a member.

In some embodiments, the security profile assigned to said computerized device by said authentication and security modules is selected from the group consisting of: a super user security profile granting essentially full access to said logger; an operator security profile granting permission to set an operational parameter of said logger and to receive and view the at least one environmental parameter; a reader security profile granting permission to receive and view the at least one environmental parameter; and a forwarder security profile granting permission to receive the at least one environmental parameter and to forward it over a network.

In some embodiments, the data access enables said computerized device to receive an environmental parameter from said logger.

In some embodiments, the environmental parameter is selected from the group consisting of: temperature, humidity, radiation, shock, atmospheric pressure, presence of a specific gas, noise and location.

In some embodiments, the data access enables said computerized device to receive, from said logger, an indication of an exception of an environmental parameter from a predefined range.

In some embodiments, said portable computerized device further comprises a network interface module configured to transmit the environmental parameter to a remote server.

In some embodiments, said network interface module of said portable computerized device comprises a wireless interface module.

In some embodiments, said network interface module of said portable computerized device comprises a wired interface module.

In some embodiments, said portable computerized device further comprises a network interface module configured to transmit the environmental parameter to an intermediary computer, for further relay by the intermediary computer to a remote server.

In some embodiments, the non-standard authentication routine comprises: transmitting a challenge from the logger to the computerized device; and transmitting a correct response to the challenge from the computerized device to the logger.

In some embodiments, the data access comprises transmitting the at least one environmental parameter from the logger to the computerized device.

In some embodiments, the data access comprises transmitting, from the logger to the computerized device, an indication of an exception of the at least one environmental parameter from a predefined range.

In some embodiments, the method further comprises transmitting the environmental parameter from the computerized device to a remote server.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. It is intended that the embodiments and figures disclosed herein are to be considered illustrative rather than restrictive. The figures are listed below.

FIG. 1 shows a network diagram of an environmental monitoring system;

FIG. 2 shows a flow chart of an environmental monitoring method; and

FIGS. 3A-3B show a data packet diagram according to an environmental monitoring protocol or data format.

### DETAILED DESCRIPTION OF THE PREFERRED EMBODIMENT

In the following detailed description, numerous specific details are set forth in order to provide a thorough understanding of embodiments. However, it will be understood by those of skill in the art that embodiments may be practiced without these specific details. In other instances, well-known methods, procedures, components, units and/or circuits have not been described in detail so as not to obscure the invention.

An aspect of some embodiments relates to a system, method and data protocol for wireless environmental monitoring of goods, such as pharmaceuticals, food articles, chemicals and/or the like. A portable environmental data logger may be coupled to the goods, and include one or more environmental sensors for continuously monitoring the environment of the goods. The sensor may be, for example, a temperature, humidity, radiation, shock, atmospheric pressure, gas, noise and/or location sensor.

A portable computerized device may be used for reading the environmental data or at least for receiving an indication of an exception of the environmental data from a desired range, by way of wireless communication with the environmental data logger. Advantageously, the wireless communication may utilize standard short-range radio modules included in the logger and the portable device, for authenticating these devices to one another by way of a unique, non-standard authentication routine.

Unless specifically stated otherwise, as apparent from the following discussions, it is appreciated that throughout the specification discussions utilizing terms such as “processing”, “computing”, “calculating”, “determining”, or the like, refer to the action and/or process of a computing system, or a similar electronic computing device, that manipulate and/or transform data represented as physical, such as electronic, quantities within the computing system's registers and/or memories into other data similarly represented as physical quantities within the computing system's memories, registers or other such.

Some embodiments may be implemented, for example, using a computer-readable medium or article which may store an instruction or a set of instructions that, if executed by a computer (for example, by a processor and/or by other suitable machines), cause the computer to perform a method and/or operations in accordance with embodiments of the invention. Such a computer may include, for example, any suitable processing platform, computing platform, computing device, processing device, computing system, processing system, computer, processor, or the like, and may be implemented using any suitable combination of hardware and/or software. The computer-readable medium or article may include, for example, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, such as C, C++, C#, Java, BASIC, Pascal, Fortran, Cobol, assembly language, machine code, or the like.

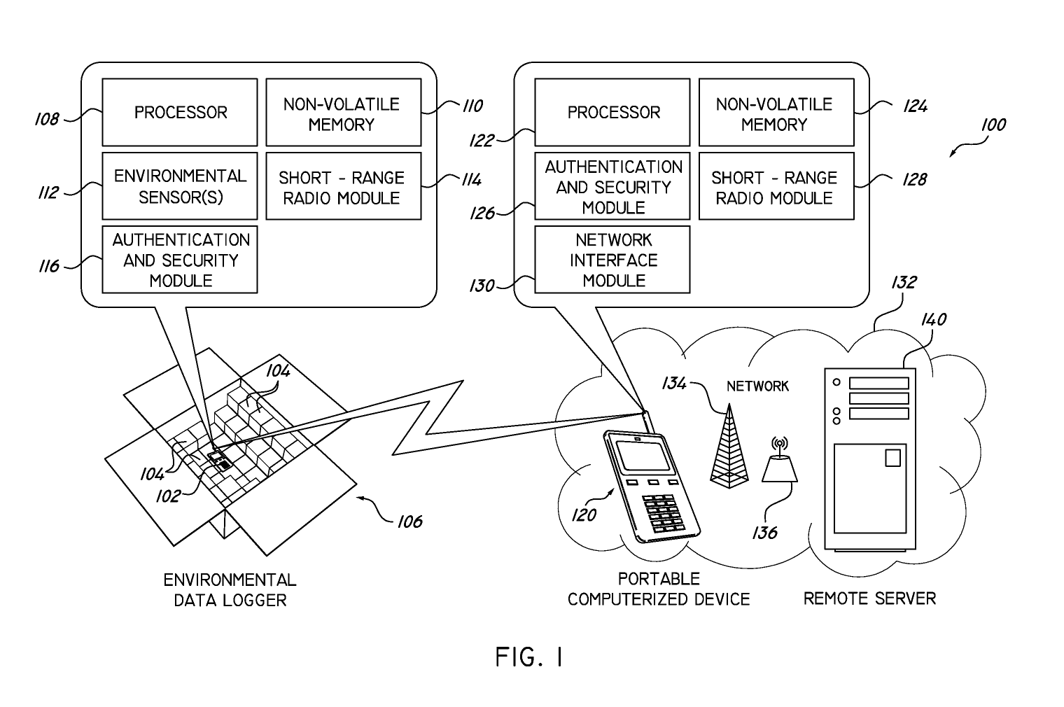

Reference is now made to FIG. 1, which shows network diagram of a system 100 for wireless environmental monitoring of goods. System 100 may include a portable environmental data logger (hereinafter “logger”) 102, a portable computerized device 120 and optionally a remote server 140.

Logger 102 may be coupled to and/or otherwise associated with goods 104, which may be packaged or not packaged. For example, logger 102 may be put inside a package 106 containing goods 104, in such a way that a sensor(s) of the logger may, being in proximity to the goods, reliably sense the environmental parameters affecting these goods. As another example, logger 102 may include a probe (not shown), which is inserted into the goods themselves (such as into a bottle of pharmaceuticals or chemicals) to monitor their contents directly.

In an embodiment, logger 102 may include a processor 108, a non-volatile memory 110, at least one environmental sensor 112, a standard short-range radio module 114, an authentication and security module 116, as well as other electronics (not shown) required for the logger's operation.

Environmental sensor 112 may be a sensor configured to sense an environmental parameter such as temperature, humidity, radiation, shock, atmospheric pressure, presence of a specific gas, noise, location and/or the like. Multiple environmental sensors, each configured to sense a different environmental parameter, may be included in logger 102 and optionally packaged together; in this case, the term “environmental sensor” 112 may refer to this aggregate of sensors. Environmental sensor 112 may be an electrical or even a digital sensor, or a mechanical sensor including an analog-to-digital converter.

Temperature monitoring may be critical for many types of goods. Some goods, such as pharmaceuticals and articles of food, may be damaged or even become unusable if subjected to temperatures beyond a specific range for a certain duration. Commonly, pharmaceuticals require a temperature-controlled environment of one of three types: (a) a cool environment of approximately 2-8 degrees Celsius; (b) an essentially room-temperature environment of approximately 15-30 degrees Celsius; or (c) a frozen environment of approximately −20 degrees Celsius. However, other temperature ranges may be similarly acceptable. A temperature sensor used as environmental sensor 112 may be, for example, a thermocouple which converts heat to a measureable voltage.

Similarly, humidity is another environmental parameter which may be monitored, since it may affect pharmaceuticals, food, electronic devices and more. A humidity sensor used as environmental sensor 112 may be an electrical hygrometer, optionally of the capacitive or resistive type.

Some goods are so sensitive, that even a small shock may cause them or their package (such as a glass bottle, ampoule etc.) to crack. Hence, environmental sensor 112 may be a shock sensor, optionally including one or more accelerometers able to detect acceleration and/or deceleration and their magnitude.

Similarly, environmental parameters such as radiation, atmospheric pressure, presence of a gas and noise (including sonic and/or ultrasonic waves) may be sensed by suitable sensors. Location may be determined using a Global Positioning System (GPS) module.

In an embodiment, standard short-range radio module (hereinafter “radio module”) 114 may be an electronic module, such as a chip, providing for short-range (commonly tens of meters to hundreds of meters, but optionally more) digital radio communication. Radio module 114 may be compliant with a standard short-range wireless technology, such as BlueTooth, Wi-Fi, or any other standard technology currently existing or introduced in the future. The term “standard” refers to a technology which is provided, maintained, licensed and/or developed by a recognized public or private organization. The BlueTooth standard is provided by the BlueTooth SIG (Special Interest Group), and currently has the following operative specifications: Core Specification v4.0, published Dec. 17, 2009; Core Specification v3.0+HS, published Apr. 21, 2009; Core Specification Addendum 1, published Jun. 26, 2008; Core Specification v2.1+EDR, published Jul. 26, 2007; Core Specification v2.0+EDR, published Nov. 10, 2004; and Volume 4: HCI Transports, published Jan. 1, 2006. These specifications are incorporated herein by reference. Wi-Fi technology is set in a series of standards maintained by the IEEE (Institute of Electrical and Electronics Engineers), which include the 802.11a, 802.11b, 802.11g and 802.11n standards. These standards are incorporated herein by reference.

Radio module 114 may be configured to communicate with other devices, such as portable computerized device 120, carrying a compatible radio module of the same standard, over a standard wireless communication channel initiated and maintained according to the pertinent standard.

Authentication and security module 116 may be a software module optionally installed in non-volatile memory 110 and executed, for example, in a volatile memory (not shown) such as a Random Access Memory (RAM) module. Alternatively, authentication and security module 116 is advantageously embedded in radio module 114, by way of utilizing a processor and one or more memories (not shown) of the radio module itself for storing and executing program code of the authentication and security module.

Portable computerized device (hereinafter computerized device) 120 may include a processor 122, a non-volatile memory 124, an authentication and security module 126, a short-range radio module (hereinafter “radio module”) 128, a network interface module 130, as well as other electronics (not shown) required for the computerized device's operation.

Computerized device 120 may be either a particular machine dedicated to communicating with loggers, such as logger 102, or a device aimed at a different purpose, such as a cellular phone, a personal digital assistant (PDA), a smart phone or the like, in which case, this device's electronics (such as its processor, memory and radio module(s)) may be advantageously used for purposes of system 100.

Authentication and security module 126 may be a software module installed in non-volatile memory 124 and executed, for example, in a volatile memory (not shown) such as a Random Access Memory (RAM) module of computerized device 120. Alternatively, authentication and security module 126 is advantageously embedded in radio module 128, by way of utilizing a processor and one or more memories (not shown) of the radio module itself for storing and executing program code of the authentication and security module.

Radio module 128 may be configured to communicate with other devices, such as logger 102, carrying a compatible radio module of the same standard, over a standard wireless communication channel initiated and maintained according to the pertinent standard.

Network interface module (“network module”) 130, which is optionally included in computerized device 120, may be a hardware device configured to connect to a network 132, such as the Internet, a cellular network and/or the like, through a cellular antenna 134, a wireless access point 136, and/or a data transfer cable (not shown). For example, network module 130 may be a cellular modem operating in a technology such as the GPRS, UMTS, HSPA, EVDO, LTE and/or WiMax technologies, and capable of transmitting and receiving packet data inside the cellular network to which they are associated or even over other networks such as the Internet. As another example, network module 130 may be a wireless network interface controller configured for connecting to a wireless local area network (WLAN) by transmitting and receiving packet data to and from a wireless access point, such as wireless access point 136, and from there to another network such as the Internet. As yet another example, network module 130 may be a cellular module providing voice and/or SMS (short messaging system) capabilities to computerized device 120. A further example is a wired interface module, which is configured to directly connect to another device (instead of or in addition to connecting to network 132) via cable, such as a USB or a different type of cable. This other device may be remote server 140 discussed below, or an intermediary computer which is, in turn, configured to relay data to remote server 140.

Optionally, computerized device 120 includes multiple network modules 130, such as those exemplified above, each providing communication capabilities in different standards, frequencies, speeds and/or the like. For example, if computerized device 120 is a cellular phone or a smart phone, it may include a cellular module providing voice and SMS services, a wireless network interface controller for connecting to a WLAN and a cellular modem for connecting to the Internet through the cellular network.

Remote server 140, which is optionally included in system 100, may be a device accessible by computerized device 120 over network 132 or via the cable. Environmental data collected by logger 102 and transmitted to computerized device 120 may be further transmitted from the computerized device to remote server 140. From a broader perspective, remote server 140 may be located in a company's headquarters, and used for receiving environmental data collected from multiple loggers 102 and transmitted to the server by multiple computerized devices 120. Additionally and alternatively, remote server 140 may be a portable device, such as a cellular phone, a smart phone, a PDA or the like, which is capable of communicating with computerized device 120 over network 132, to receive the environmental data.

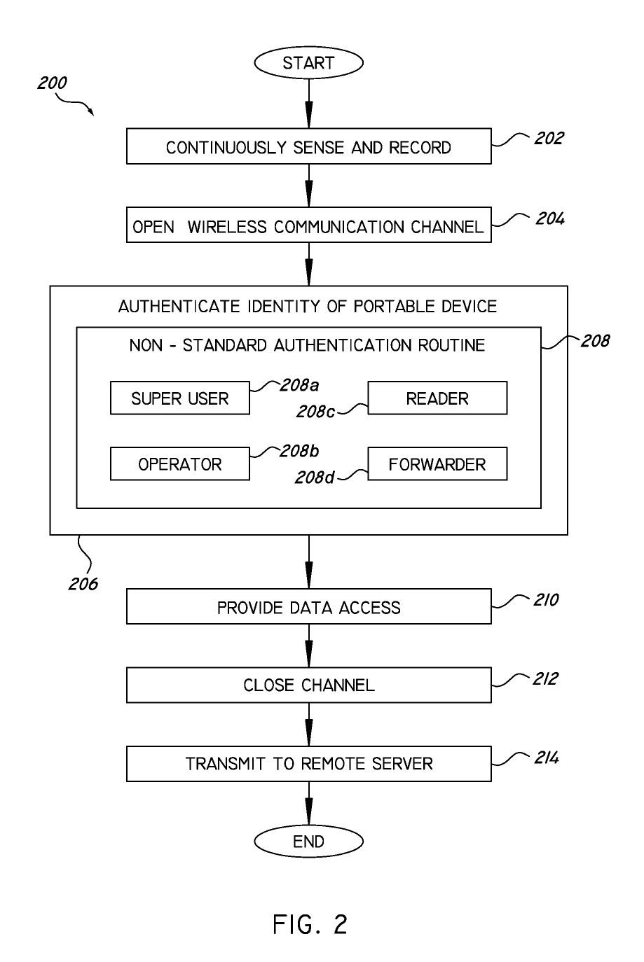

Reference is now made to FIG. 2, which shows a method 200 for wireless environmental monitoring of goods, in which the operation of different elements of system 100 of FIG. 1 is discussed. Method 200 illustrates how environmental data pertaining to the goods and/or their environment is monitored, recorded and transmitted.

In a block 202, environmental data, such as a quantified parameter pertaining to temperature, humidity, radiation, shock, atmospheric pressure, presence of a specific gas, noise, location and/or the like is continuously monitored, by sensing the environment and recording the parameter. This is performed in environmental data logger 102 of FIG. 1. The sensing itself may be performed by environmental sensor(s) 112 of FIG. 1. The term “continuously” may refer to an instantaneous sampling (or “sensing”) operation being performed, periodically, every X seconds, minutes, hours etc. The result of the sampling is then recorded in a non-volatile memory, such as non-volatile memory 110 of FIG. 1, which may include a database of the samplings. Table 1 shows such an exemplary database, having temperature records for every 5 minutes.

TABLE 1
Exemplary Temperature Database

| Date and Time | Temperature (° C.) |
|---|---|
| 01/01/2010 00:05:00 | 5 |
| 01/01/2010 00:10:00 | 8.5 |
| 01/01/2010 00:15:00 | 11 |
| 01/01/2010 00:20:00 | 10.5 |
| . . . | . . . |

Alternatively, in order to save storage space, only exceptions of the environmental parameter(s) from a predetermined range over a predetermined duration are stored in non-volatile memory 110 of FIG. 1. This may enable the usage of a simpler (and often cheaper) logger, having a smaller non-volatile memory.

The monitoring of block 202 may be performed automatically, for example, while the goods to which logger 102 of FIG. 1 is attached are in transit, such as in a truck, a ship, on board an aircraft or the like. Alternatively, the monitoring may be performed on goods in situ, such as goods stored in a warehouse—in which case logger 102 of FIG. 1 may be either freely placed in proximity to the goods or permanently fixed to a permanent element in their area.

Upon arrival of the goods to their destination or to any interim point, a portable computerized device, such as computerized device 120 of FIG. 1, may be used for communicating with the logger associated with the goods, in order to discover the environmental parameter(s) which influenced the goods during their travel. Particularly, is may be desired to know if the environmental parameter(s) have exceeded any pre-determined range which was originally specified in the logger—in which case, the goods may be rendered damaged and should be further inspected or even discarded. Similarly, if the goods are in storage and not in transit, it may be desired to periodically check whether the environmental parameter(s) have exceeded the pre-determined range since the last check. The computerized device may, additionally or alternatively, be manually operated by a human.

Therefore, in a block 204, logger 102 and computerized device 120 of FIG. 1 may communicate with one another by opening a standard wireless communication channel, according to an appropriate procedure specified in the pertinent standard. Commonly, computerized device 120 of FIG. 1 may transmit an interrogation signal, to determine if any loggers are in range. A logger, such as logger 102 of FIG. 1 receiving this signal, may transmit a response signal. Then, logger 102 and computerized device 120 of FIG. 1 may negotiate a connection and provide a wireless communication channel, according to the pertinent standard and optionally of the packet data type, over which data may be transmitted.

In a block 206, advantageously, a non-standard authentication routine (hereinafter “routine”) 208 may be executed in both logger 102 and computerized device 120 of FIG. 1 (although it may not be identical in both), in order to authenticate the identity of the computerized device to the logger, thereby preventing non-authorized computerized devices from maliciously or accidentally accessing the logger. The term “non-standard” may refer to a routine (or a “procedure”) disclosed herein, which is not part of the standard wireless communication channel opened in block 204. For example, in case radio module 114 and 128 in FIG. 1 are of the BlueTooth type, the non-standard authentication routine may be different than any authentication, security and/or related protocols specified by any of the BlueTooth standard's specifications.

Using a non-standard authentication routine, as opposed to an authentication, security and/or related protocols provided by the pertinent standard may advantageously increase the security of the information, namely—the environmental data, stored in the logger. Firstly, the usage of a non-standard authentication routine may prevent malicious users from penetrating into a logger, since the specifics of the security key and optionally other parameters negotiated throughout the routine may not be readily known to them. Such a malicious user may perhaps manage to open a standard wireless communication channel from a capable computerized device (external to the system) to the logger, but may then be prohibited from and unable to pull any environmental data over that channel.

Secondly, in a broader view, the routine may enable maintaining and operating a system having a group of multiple loggers and computerized devices for reading these loggers. The non-standard authentication routine is, advantageously, suited for such large-scale systems; it may differ from standard authentication and/or security protocols by the fact that it allows for rapid and sequential probing of multiple loggers, as opposed to many standard short-range radio protocols which are intended for small-scale (usually one-to-one) communication purposes. For example, the BlueTooth standard uses a pairing procedure in which a PIN code must be entered in order to establish communications with each new device. This makes it quite cumbersome to perform rapid automatic or manual probing of multiple loggers, since it means that either a same PIN code must be given to all loggers (which may render the security ineffective), or that the PIN for each logger must somehow become known to the portable device performing the reading or to the person operating it.

Lastly, many existing wireless communication standards offer security means which may be insufficient, and may be penetrable by experienced computer security professionals.

With reference to FIG. 1, system 100 may include a plurality of loggers 102, a plurality of computerized devices 120 and optionally one or more remote servers 140 which are referred to as central shipment tracking and monitoring server(s). In such a case, system 100 may be referred to as a system for shipment tracking and monitoring. For example, an entity such as a shipping company or a company utilizing the services of a shipping company may maintain such a system. The routine in the system's loggers may only grant data access to its resources to a computerized device which correctly completes an authentication and security process, which is based on matching (though optionally, not identical) security keys and/or credentials found in the computerized device and the logger. The completion of the authentication and security process, in its basic form, requires the computerized device to transmit a valid response to a challenge (optionally encrypted) sent to the computerized device by the logger. The response itself may be a hashing/encryption result of the challenge (or a variation thereof) and/or transmission of one more credentials. The key(s) found in the computerized device may be according to the access level which is desired for the computerized device. Each entity using the system may use a different key(s) and/or credentials, so as to prevent one entity's loggers from disclosing information to another entity's computerized devices.

Each logger in one entity's system may be assigned with a unique identifier (such as a serial number) and one or more group identifier(s). Each computerized device, in its routine, may include a list of loggers (unique or group) identifiers which are associated with that entity and are thus accessible by the entity's computerized devices.

Optionally, each logger may contain security keys (usually, loggers from the same group will contain the same keys), a key for each security profile (for example, there will be a forwarder key, a reader key etc. The minimum is a super user key, which allows to set other keys). Each computerized device may also contain keys (according to the access level it needs to have) for the different logger groups which it is meant to access. The access level given to a computerized device is determined by the key it used to create the response during the authentication process. The different security profiles may allow different capabilities and controllability.

In a more rigorous security scenario, each computerized device in one entity's system may be also assigned with a unique identifier. Then, each logger, in its routine, may include a list of computerized devices identifiers which are authorized to access it.

The non-standard authentication routine may include, for example, one or more of the following stages:

A. (Optional) Hint retrieval: The computerized device sends a request to get an authentication hint, which will help it search more quickly for a matching key (instead of trying all the possible keys which it contains). The logger sends the hint, if it indeed has such a hint, back to the computerized device. Of course, if the found device is not a logger, it will not recognize the hint retrieval command sent to it by the computerized device, and the connection will be closed. The hint may be, for example:
The logger's identifier. In this case, the computerized device will have a list of all the identifiers of the loggers it can access. Alternatively, if all loggers in a certain group are given the same identifier, the computerized device may simply look for this group identifier when it receives hint responses from loggers.
A part of the logger's identifier. In this case, a portion of the logger's identifier may serve as the hint. For instance, the hint may be “ABC9345034535”, where “ABC” is the hint—which identifies, for example, the group of loggers which the computerized device may access (ABC may be a company name etc.) Upon a request from a computerized device, the logger may either transmit only the portion of the identifier which constitutes the hint, or the entire identifier; in the latter case, the computerized device may parse the identifier and extract the hint from it.
A data piece separate from the identifier. For example, all loggers which are part of the same group may include a same hint stored in their non-volatile memories, which is transmitted in response to a request by a computerized device.

B. Challenge request: If the computerized device does not have a matching hint, it means that it does not have a matching key, and it closes the connection and moves on to the next device found. If it finds a matching hint, or if hints are not used, the computerized device sends the logger a request for a challenge. The term “challenge”, as referred to herein, may relate, essentially, to either a static challenge or a dynamic challenge. A static challenge is, for example, a request to enter a set of credentials such as a user name and/or a password, a PIN number etc.—which is predefined and may be changed every once in a while. A dynamic challenge, which is often considered more secure, is a randomly-generated data sequence, the response to which is created by applying a certain function to the sequence. Challenge-response authentication is further discussed in Challenge-response authentication. (2010, Jun. 22). In Wikipedia, The Free Encyclopedia. Retrieved 06:53, Jul. 19, 2010, from http://en.wikipedia.org/w/index.php?title=Challenge-response_authentication&oldid=369496236, which is incorporated herein by reference. The logger then sends a challenge to the computerized device.

C. Response verification stage: If a static challenge was used, the response may simply be the requested user name, password, PIN number and/or the like. If, on the other hand, a dynamic challenge was used, the computerized device may use the security key with the highest available permissions for the given logger and/or logger group (according to the hint; otherwise, it will try every possible group), to hash/encrypt the challenge or a variation thereof, based on a predefined function. This is the “response”. It then sends this response to the logger, along with the type of the security key it used (forwarder/reader/operator/superuser etc.), optionally in an encrypted form. The logger may also calculate the appropriate response, based on the type of key used. If the result calculated by the logger matches the response sent by the computerized device, the keys match and the computerized device gets data access to the logger (according to the privileges of the key used for the response verification). If the result doesn't match—the key is incorrect, and the connection is closed by the logger. The computerized device may then retry the authentication stage for a number of times. If all fails—it moves on to the next found device.

A large-scale system may be used, for example, in the following scenario: A shipping company may allocate a number of loggers to pharmaceutical company A, using specific identifiers and security keys, and allocate a number of other loggers to pharmaceutical company B, using different identifiers and keys. This allows contact persons of companies A and B to be stationed even at the same physical point in order to perform reading of the loggers, without company A's person being able to read company B's loggers, and vice versa.

Another example to the usage of such a large-scale system is when a shipping company A allocates a number of loggers to its own shipping services, using specific identifiers and security keys, and receives a number of loggers carrying different identifiers and security keys from pharmaceuticals company B, which uses shipping company A's services. Shipment company A cannot read the data of pharmaceuticals company B, because of the different security keys. It can, however, pass notification of an exception condition to pharmaceuticals company B, if its computerized devices are given a forwarder security profile (as discussed below) for pharmaceuticals company B's loggers.

For example, the security profiles may include a super user security profile 208a, an operator security profile 208b, a reader security profile 208c and a forwarder security profile 208d. Super user security profile 208a may grant essentially full access to the logger. A super user may be allowed, for example, to create, delete and change other security profiles, to change security keys in the logger, to change the logger's identifier, to cause the logger to transmit the recorded environmental parameter(s) to the computerized device and to view them on the device, and to set one or more operational parameters such as to define environmental parameter thresholds, schedule future monitoring sessions, stop the current monitoring, start a monitoring session, erase data, etc.

Operator security profile 208b may be inferior to super user security profile 208a in that it grants permission to set the one or more operational parameters and cause the logger to transmit the recorded environmental parameter(s) and to view them, as mentioned above, but may prohibit handling the security profiles, keys and identifier.

Reader security profile 208c may only grant permission to receive and view the at least one environmental parameter.

A forwarder security profile 208d may grant permission to receive the environmental parameter(s) but not to view them. This may be useful in scenarios where it is desired that the user handling the computerized device which accesses the logger will not be able to view the environmental data, only to relay it over a network.

Those of skill in the art will recognize that these four security profiles are only meant to be illustrative, and that data access level to the logger may be arranged differently.

In a block 210, upon successful authentication of the computerized device to the logger and the optional assignment of a security profile, the computerized device may be granted with data access to the logger. The term “data access”, as referred to herein, may refer to any of the actions discussed above with reference to the exemplary security profiles.

The data access may be used, as mentioned, to cause the logger to transmit the environmental parameter(s), which were recorded over time, to the computerized device. Additionally or alternatively, the data access may be used to only cause the logger to transmit an indication of whether the predefined threshold of the environmental parameter(s) has been exceeded or not. Such a binary true/false indication may be sufficient in some scenarios.

In a block 212, when the environmental parameter(s) and/or the indication has been transmitted from the logger to the computerized device, the wireless communication channel which had been opened in block 204 may be closed.

In some scenarios, a single computerized device (or a small number of devices) may need to access multiple loggers, such as when a shipment containing multiple loggers arrives at a destination. The computerized device may therefore be configured to automatically and sequentially access one logger after the other, to collect the environmental parameter(s) from all these loggers; in terms of method 200, blocks 204-212 may be repeated for each logger present in the vicinity of the computerized device. In such scenarios, the speed of execution of blocks 204-212 may be important. Therefore, the computerized device may be configured, if encountering multiple loggers simultaneously (such as an amount of loggers exceeding a predetermined number), to cause the loggers to only transmit the binary indication. Optionally, if the binary indication indicates that an exception has occurred, a full reading of that logger may be performed—namely, the logger may be requested to transmit the entirety of the environmental parameter(s), so that the nature of the occurrence may be further investigated and understood.

In a block 214, the environmental parameter(s) and/or the indication are optionally transmitted to a remote server, either wirelessly or via cable. This feature may be better understood with reference to FIG. 1. After the environmental parameter(s) have been received by computerized device 120, it may optionally transmit these parameter(s) to a remote server 140. If system 100 having multiple loggers 102 and computerized devices 120 is used by a certain entity, the computerized devices may, advantageously, serve as relays that overcome the shortcomings of the loggers in transmitting environmental data to great distances and to remote locations. An entity operating system 100 may concentrate environmental data pertaining to a large number of shipments in a central location, such as in server 140. Server 140 may be part of or linked to a shipping or warehousing management system, and may contribute the added value of environmental monitoring to this management system.

The transmittal of the environmental parameter(s) from computerized device 120 to server 140 over network 132 may be carried out, for example, by incorporating it in an electronic mail (e-mail) message. The SMTP (Simple Mail Transfer Protocol) protocol may be used, where the environmental parameter(s) are attached to an email message and transmitted, for example, over port 25 of network interface module 130.

Additionally or alternatively, the transmittal may be performed by sending the environmental parameter(s) in an SMS message. However, since the length of the SMS message may be limited, only an indication of an exception, or only a summary of the environmental parameter(s) may be transmitted. The summary may include, for example, records (including date/time and environmental parameter value) based on which an exception has been detected, due to their deviation from a predefined range.

Additionally or alternatively, the transmittal may be performed using a peer-to-peer (P2P) data channel between computerized device 120 and server 140. Computerized device 120 may initiate a P2P connection to server 140 according to the server's known IP address or domain name, over a predefined port at the computerized device and at the server.

Further examples to how the transmittal may be done are a direct connection to a database server through a predefined or a dynamically defined domain name or IP address; sending the data over HTTP or HTTPS protocols (and, if necessary, utilizing an encoding, for example BASE64), to be saved in a database or as a file; uploading the data using a protocol such as FTP, FTPS, SMB etc.; uploading the data to a proprietary server software, using a proprietary client module on the computerized device; and sending the data over a packet data channel utilizing the cellular network (for example, over GPRS, UMTS etc.).

### EXAMPLES

Table 2 includes an exemplary wireless environmental monitoring protocol, which is further discussed below the table. Alternatively, the contents of Table 2 may be referred to as a data format to be used in loggers such as logger 102 of FIG. 1. This exemplary data format may characterize data stored in non-volatile memory 110 of logger 102. The term “BluEx” used in table 2 is meant merely to identify this exemplary data format, and is only illustrative. For reasons of simplicity, this exemplary data format only shows temperature and humidity measurements.

TABLE 2
Exemplary Logger Data Format

| | Size in octets | |
|---|---|---|
| Field Name | (bytes) | Notes |
| BluEx message | 5 | “BluEx” |
| identifier | | UTF-8 bit format |
| Message Type | 1 | 0x00 - Reserved |
| | | (not used) |
| | | 0x01 - Temperature |
| | | data |
| | | 0x02 - Humidity |
| | | data |
| | | 0x03 - Temp & |
| | | Humidity data |
| | | >=0x80 - Extended |
| | | format |
| Serial Number | 1 | Unsigned |
| Length | | |
| Serial Number | FF + Serial number | UTF-8 string |
| | length | |
| Tracking number | 1 | Unsigned |
| Length | | FF means no |
| | | tracking number |
| Tracking Number | FF + Tracking | UTF-8 string |
| | number length | if tracking number |
| | | length is not FF |
| Recording | FF + 2 | Unsigned |
| Description length | | |
| Recording | FF + Recording | UTF-8 string |
| Description | description length | if recording |
| | | description length |
| | | is not 0 |
| Recording | FF + 4 | Unsigned. |
| Start time | | seconds from clock |
| | | synchronization time |
| Is recording | 1 | FF - No |
| Stopped | | Any other value - |
| | | Yes |
| Memory Full | 1 | FF - No (relevant |
| | | only if “Is recording |
| | | stopped” is not “FF” |
| Recording | FF + 4 | Unsigned. |
| Stop time | | seconds from clock |
| | | synchronization time |

The following section applies to loggers with
temperature sensing capabilities

| | | |
|---|---|---|
| Temperature | 1 | 1 - Centigrade |
| Type | | 2 - Ferenheight |
| | | 3- Kelvin |
| Is Temp High | 1 | . |
| Alarm Set | | FF - No |
| | | Any other value - |
| | | Yes |
| High Alarm Temp | FF + 4 | Signed, 100 times |
| Value | | the actual value, in order to |
| | | avoid transferring float |
| | | This value is only |
| | | available if “Is High Temp |
| | | Alarm Set” is not “FF” |
| High Temp Alarm | FF + 4 | Unsigned |
| Time Threshold | | This value is only |
| (Seconds) | | available if “Is High Temp |
| | | Alarm Set” is not “FF” |
| High Temp Alarm | 1 | FF - No |
| Sequential | | (accumulated time) |
| | | This value is only |
| | | available if “Is High Temp |
| | | Alarm Set” is not “FF” |
| Is Temp Low Alarm | 1 | Unsigned. |
| Set | | FF - No |
| | | Any other value - |
| | | Yes |
| Low Alarm Temp | FF + 4 | Signed. 100 times |
| Value | | the actual value, in order to |
| | | avoid transferring float |
| | | This value is only |
| | | available if “Is Low Temp |
| | | Alarm Set” is not “FF” |
| Low Temp Alarm | FF + 4 | Unsigned |
| Time Threshold | | This value is only |
| (Seconds) | | available if “Is Low Temp |
| | | Alarm Set” is not “FF” |
| Low Temp Alarm | 1 | FF - No |
| Sequential | | (accumulated time) |
| | | This value is only |
| | | available if “Is Low Temp |
| | | Alarm Set” is not “FF” |
| Is Alarm Temp | 1 | FF - No |
| Triggerred | | Any other value - |
| | | Yes |

The following section applies to loggers with
humidity sensing capabilities

| | | |
|---|---|---|
| Humidity Type | 1 | 1 - Percentage |
| Is Humidity High | 1 | Unsigned. |
| Alarm Set | | FF - No |
| | | Any other value - |
| | | Yes |
| High Alarm | FF + 1 | Unsigned. |
| Humidity Value | | This value is only |
| | | available if “Is High |
| | | Humidity Alarm Set” is not |
| | | “FF” |
| High Humidity | FF + 4 | Unsigned |
| Alarm Time | | This value is only |
| Threshold | | available if “Is High |
| (Seconds) | | Humidity Alarm Set” is not |
| | | “FF” |
| High Humidity | 1 | FF - No |
| Alarm Sequential | | (accumulated time) |
| | | This value is only |
| | | available if “Is High |
| | | Humidity Alarm Set” is not |
| | | “FF” |
| Is Humidity Low | 1 | Unsigned. |
| Alarm Set | | FF - No |
| | | Any other value - |
| | | Yes |
| Low Alarm | FF + 1 | Unsigned. |
| Humidity Value | | This value is only |
| | | available if “Is Low |
| | | Humidity Alarm Set” is not |
| | | “FF” |
| Low Humidity | FF + 4 | Unsigned |
| Alarm Time | | This value is only |
| Threshold | | available if “Is Low |
| (Seconds) | | Humidity Alarm Set” is not |
| | | “FF” |
| Low Humidity | 1 | FF - No |
| Alarm Sequential | | (accumulated time) |
| | | This value is only |
| | | available if “Is Low |
| | | Humidity Alarm Set” is not |
| | | “FF” |
| Is Humidity Alarm | 1 | FF - No |
| Triggerred | | Any other value - |
| | | Yes |
| Measurement | FF + 4 | Unsigned |
| Interval | | In seconds |
| Measurements | FF + 4 | Unsigned |
| Count | | |

Measurement Data
The following data (measured temperature and measured humidity
repeates itself “Measurements Count” times
The following section applies to temperature logger

| | | |
|---|---|---|
| Measured | FF + 4 | Signed 100 times |
| temperature | | the actual value in order to |
| | | avoid |
| | | transferring floar |

The following section applies to humidity Logger

| | | |
|---|---|---|
| Measured | FF + 1 | Unsigned |
| Humidity | | |

END OF MESSAGE - CHECKSUM

| | | |
|---|---|---|
| CHECKSUM | FF + Checksum size | Checksum bytes |
| | | (includes header) |

The letters “FF” which appear in table 2, under the size column, are meant to denote escaping, that is, avoiding the need to send a byte (independently or as part of a byte sequence) which has all its bits set to zero, which is necessary for some platforms and/or radio modules.

The following exemplary scheme may be used: Prior to the byte (or bytes sequence) a single byte (preamble) is sent, which represents how many zero bytes follow, where the preamble's bits specify the location of the zero bytes in the sequence (the most significant bit represents the most significant byte). For example: The sequence of bytes (in hexadecimal representation): 00 05 will be represented in FF escaping as: 7F XX 05 (where “XX” can be any non-zero value, but will be treated as zero when decoding is performed). The sequence of bytes: 05 00 will be represented in FF escaping as: BF 05 XX (where “XX” can be any non-zero value, but will be treated as zero when decoding is performed). Long byte sequences will be encoded using multiple FF bytes.

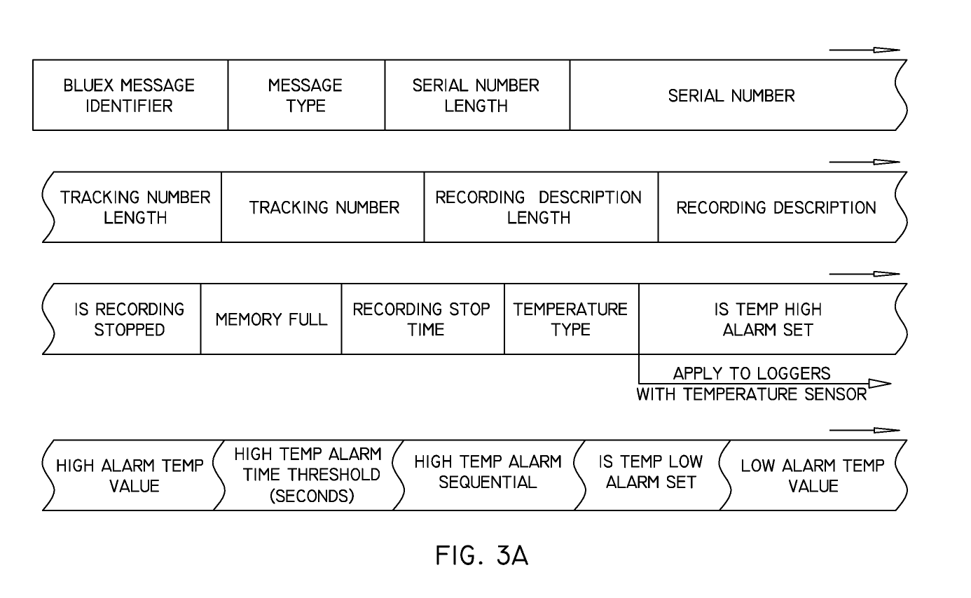

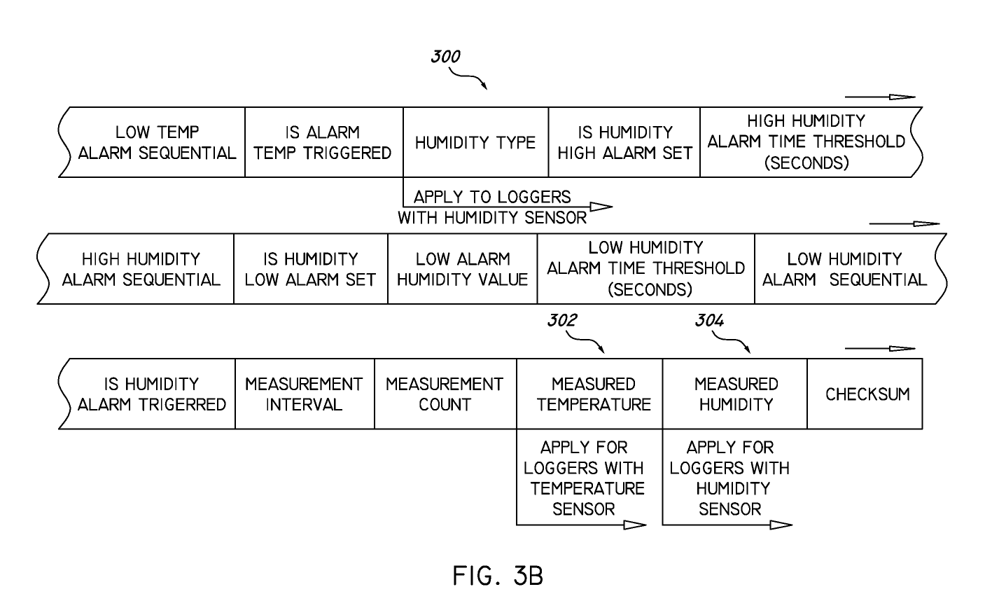

Some of the contents of Table 2 are illustrated in FIGS. 3A-B, which show the exemplary data format visually. The data format begins in FIG. 3A and continues in FIG. 3B, due to its length. In addition, this data format may be advantageously transmittable in a plurality of data packets over a packet data network, such as network 132. For this purpose, the data format may be treated as a wireless environmental monitoring protocol which defines data packets such as a data packet 300, including a plurality of sequential sections (“fields” in table 2) each occupying a certain length of bits. Not all fields shown in data packet 300 may be necessarily present in a data packet. These fields are shown for illustrative purposes. “Measured temperature” 302 and/or “measured humidity” 304 sections of data packet 300 may be relatively long, since they contain many temperature/humidity records that are stored in the logger. Therefore, the length of these sections may be limited, so that the entirety of the records is transmitted over a plurality of packets such as packet 300.

Table 3 shows exemplary logger command messages, which may be transmitted from computerized device 120 to logger 102 of FIG. 1, in order to, for example, create, delete and change other security profiles, change security keys in the logger, change the logger's identifier, cause the logger to transmit the recorded environmental parameter(s) to the computerized device, set one or more operational parameters such as to define environmental parameter thresholds, schedule future monitoring sessions, stop the current monitoring, start a monitoring session etc.

For simplicity of presentation, 5 exemplary command types are shown in table 3:
0×01—Interval Settings
0×02—Temperature Alarm Sellings
0×04—Recording Action (Start/Stop)
0×05—Reset (Memory/All)
0×06—Get Data

TABLE 3
Exemplary Logger Command Messages

| | | |
|---|---|---|
| | Size in octets | |
| Field Name | (bytes) | Notes |

Set Measurement Intervals

| | | |
|---|---|---|
| BluEx message | 5 | “BluEx” |
| identifier | | UTF-8 bit format |
| Command Type | 1 | 0x01 |
| Measurement | FF + 4 | Unsigned |
| Interval | | In seconds |

Set High/Low Temperature Alarm

| | | |
|---|---|---|
| BluEx message | 5 | “BluEx” |
| identifier | | UTF-8 bit format |
| Command Type | 1 | 0x02 |
| Sub - Type | 1 | 0x01 - High Alarm |
| | | 0x02 - Low Alarm |
| Is Alarm Set | 1 | Unsigned |
| | | FF - No |
| | | Any other value - |
| | | yes |
| Alarm Temperature | FF + 4 | Signed |
| Value | | 100 times the actual |
| | | value |
| | | Only sent if “Is |
| | | Alarm set” is different from |
| | | FF |
| Alarm Time | FF + 4 | Unsigned Seconds |
| threshold | | Only sent if “Is |
| | | Alarm set” is different from |
| | | FF |
| Alarm Time | 1 | FF- No |
| Sequential | | any other value - |
| | | yes |
| | | Only sent if “Is |
| | | Alarm set” is different from |
| | | FF |

Recording Action (start/stop)

| | | |
|---|---|---|
| BluEx message | 5 | “BluEx” |
| identifier | | UTF-8 bit format |
| Command Type | 1 | 0x04 |
| Sub-Type | 1 | 0x01 - Start |
| | | (Effective only if memory |
| | | is resetted) |
| | | 0x02 - Stop |

Reset Action (memory/all)

| | | |
|---|---|---|
| BluEx message | 5 | “BluEx” |
| identifier | | UTF-8 bit format |
| Command Type | 1 | 0x05 |
| Sub-Type | 1 | 0x01 - Memory |
| | | reset (configuration does |
| | | not change) |
| | | 0x02 - Reset to |
| | | factory defaults (not |
| | | including internal clock) |

Get Data

| | | |
|---|---|---|
| BluEx message | 5 | “BluEx” |
| identifier | | UTF-8 bit format |
| Command Type | 1 | 0x06 |
| CHECKSUM | FF + Checksum size | Checksum bytes |
| | | (including header) |

While a number of exemplary aspects and embodiments have been discussed above, those of skill in the art will recognize certain modifications, permutations, additions and sub-combinations thereof. It is therefore intended that the following appended claims and claims hereafter introduced be interpreted to include all such modifications, permutations, additions and sub-combinations as are within their true spirit and scope.

In the description and claims of the application, each of the words “comprise” “include” and “have”, and forms thereof, are not necessarily limited to members in a list with which the words may be associated.

What is claimed is:

1. A system for wireless environmental monitoring of goods, the system comprising a portable environmental data logger and a portable computerized device, each comprising:
a standard short-range radio module; and
an authentication and security module,
wherein said standard short-range radio modules of said logger and said computerized device are configured to communicate with one another over a standard wireless communication channel, and
wherein said authentication and security modules of said logger and said computerized device are each configured to execute, over the standard wireless communication channel, a non-standard authentication routine for authenticating an identity of said computerized device to said logger, so as to provide said computerized device with data access to said logger based on a security profile assigned to said computerized device.

2. The system according to claim 1, wherein, in the execution of the non-standard authentication routine:
said authentication and security module of said logger is further configured to transmit a challenge to the authentication and security module of said computerized device; and
said authentication and security module of said computerized device is further configured to transmit a correct response to the challenge to the authentication and security module of said logger, to provide said computerized device with the data access to said logger.

3. The system according to claim 2, wherein the correct response is associated with a group of loggers in which said logger is a member.

4. The system according to claim 2, wherein the correct response is associated with a group of computerized devices in which said computerized device is a member.

5. The system according to claim 1, wherein the security profile assigned to said computerized device by said authentication and security modules is selected from the group consisting of:
a super user security profile granting essentially full access to said logger;
an operator security profile granting permission to set an operational parameter of said logger and to receive and view the at least one environmental parameter;
a reader security profile granting permission to receive and view the at least one environmental parameter; and
a forwarder security profile granting permission to receive the at least one environmental parameter and to forward it over a network.

6. The system according to claim 1, wherein the data access enables said computerized device to receive an environmental parameter from said logger.

7. The system according to claim 6, wherein the environmental parameter is selected from the group consisting of: temperature, humidity, radiation, shock, atmospheric pressure, presence of a specific gas, noise and location.

8. The system according to claim 1, wherein the data access enables said computerized device to receive, from said logger, an indication of an exception of an environmental parameter from a predefined range.

9. The system according to claim 8, wherein the environmental parameter is selected from the group consisting of: temperature, humidity, radiation, shock, atmospheric pressure, presence of a specific gas, noise and location.

10. The system according to claim 1, wherein said portable computerized device further comprises a network interface module configured to transmit the environmental parameter to a remote server.

11. The system according to claim 10, wherein said network interface module of said portable computerized device comprises a wireless interface module.

12. The system according to claim 10, wherein said network interface module of said portable computerized device comprises a wired interface module.

13. The system according to claim 1, wherein said portable computerized device further comprises a network interface module configured to transmit the environmental parameter to an intermediary computer, for further relay by the intermediary computer to a remote server.

14. A system for shipment tracking and monitoring, the system comprising:
a central shipment tracking and monitoring server;
a plurality of portable environmental data loggers, each configured to monitor an environmental parameter and to store tracking information pertaining to a shipment; and
a plurality of portable computerized devices, each configured to wirelessly access at least one of the loggers so as to receive the environmental parameter, and each comprising a network interface module configured to transmit the environmental parameter to the central shipment tracking and monitoring server.

15. A method for wireless environmental monitoring of goods, the method comprising:
continuously sensing and recording, using a portable environmental data logger, at least one environmental parameter;
opening a wireless communication channel from a portable computerized device to the logger, using a standard short-range radio protocol; and
over the wireless communication channel, using a non-standard authentication routine, authenticating an identity of the computerized device to the logger, to provide the computerized device with data access to the logger based on a security profile assigned to the computerized device.

16. The method according to claim 15, wherein the security profile is selected from the group consisting of:
a super user security profile granting essentially full access to said logger;
an operator security profile granting permission to set an operational parameter of said logger and to receive and view the at least one environmental parameter;
a reader security profile granting permission to receive and view the at least one environmental parameter; and
a forwarder security profile granting permission to receive the at least one environmental parameter and to forward it over a network.

17. The method according to claim 15, wherein the non-standard authentication routine comprises:
transmitting a challenge from the logger to the computerized device; and
transmitting a correct response to the challenge from the computerized device to the logger.

18. The method according to claim 17, wherein the correct response is associated with a group of loggers in which the logger is a member.

19. The method according to claim 17, wherein the correct response is associated with a group of computerized devices in which the computerized device is a member.

20. The method according to claim 15, wherein the data access comprises transmitting the at least one environmental parameter from the logger to the computerized device.

21. The method according to claim 20, wherein the environmental parameter is selected from the group consisting of: temperature, humidity, radiation, shock, atmospheric pressure, presence of a specific gas, noise and location.

22. The method according to claim 15, wherein the data access comprises transmitting, from the logger to the computerized device, an indication of an exception of the at least one environmental parameter a predefined range.

23. The method according to claim 22, wherein the environmental parameter is selected from the group consisting of: temperature, humidity, radiation, shock, atmospheric pressure, presence of a specific gas, noise and location.

24. The method according to claim 15, further comprising transmitting the environmental parameter from the computerized device to a remote server.
